(19) United States
(12) Patent Application Publication
(10) Pub. No.: US 2025/0189922 A1
(43) Pub. Date: Jun. 12, 2025

(54) IMAGE FORMING APPARATUS AND NON-TRANSITORY COMPUTER READABLE STORAGE MEDIUM

(71) Applicant: FUJIFILM Business Innovation Corp., Tokyo (JP)

(72) Inventor: Muneyuki NISHIMURA, Kanagawa (JP)

(73) Assignee: FUJIFILM Business Innovation Corp., Tokyo (JP)

(21) Appl. No.: 18/668,273

(22) Filed: May 20, 2024

(30) Foreign Application Priority Data
Dec. 6, 2023 (JP) 2023-206319

(51) Int. Cl. G03G 15/00

(52) U.S. Cl. CPC G03G 15/6558; G03G 15/6511

(57) ABSTRACT

An image forming apparatus includes: a loading unit on which a recording medium on which an image is to be formed is loaded; an image forming unit that forms the image, on which adjustment processing is performed before image formation processing on a recording medium starts; a blowing unit that blows gas onto the recording medium loaded on the loading unit before the image formation processing on the recording medium starts; and a processor that sets, based on adjustment time that is a time in which the image forming unit is adjusted and blowing time that is a time in which the gas is blown, start timing of at least one of blowing start timing that is a timing at which blowing of the gas starts and adjustment processing start timing that is a timing at which the adjustment processing starts.

### CROSS-REFERENCE TO RELATED APPLICATIONS

This application is based on and claims priority under 35 USC 119 from Japanese Patent Application No. 2023-206319 filed Dec. 6, 2023.

### BACKGROUND

### (i) Technical Field

The present invention relates to an image forming apparatus and a non-transitory computer readable storage medium.

### (ii) Related Art

JP2003-140430A discloses processing of switching instruction contents to be given to an image forming means between operation preparation processing in a speed mode dedicated to a monochrome image and operation preparation processing in a speed mode corresponding to a color image.

JP2011-5671A discloses a configuration of, when a specified number of times of image formation is equal to or less than a predetermined number, avoiding execution of adjustment processing for adjusting the quality of an image formed in image formation processing.

JP2009-120396A discloses processing of determining whether the number of sheet feed trays continuing a blowing operation is equal to or more than a predetermined number, and when the number exceeds the predetermined number, stopping the blowing operation in any of the sheet feed trays performing the blowing operation.

### SUMMARY

In an image forming apparatuses, formation of an image on a recording medium may start after adjustment processing of an image forming means that forms the image is performed or blowing processing of a gas onto the recording medium is performed.

Here, in a case of a configuration in which the blowing processing uniformly starts in accordance with the start of the adjustment processing, a situation may occur in which one of the two pieces of processing ends first and only the other piece of processing is continuously performed. When time elapses in a situation in which only the other piece of processing is performed, a situation may occur in which a state of the processing target subjected to the one piece of processing changes, an environment around the processing target changes, or the like.

Aspects of non-limiting embodiments of the present disclosure relate to an image forming apparatus that can make a time period from an end of one of adjustment processing and blowing processing that ends first to an end of the other processing shorter than in a configuration in which the gas blowing processing uniformly starts in accordance with a start of the adjustment processing of an image forming unit.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus comprising: a loading unit on which a recording medium on which an image is to be formed is loaded; an image forming unit that forms the image, on which adjustment processing is performed before image formation processing on a recording medium starts; a blowing unit that blows gas onto the recording medium loaded on the loading unit before the image formation processing on the recording medium starts; and a processor that sets, based on adjustment time that is a time in which the image forming unit is adjusted and blowing time that is a time in which the gas is blown, start timing of at least one of blowing start timing that is a timing at which blowing of the gas starts and adjustment processing start timing that is a timing at which the adjustment processing starts.

### BRIEF DESCRIPTION OF THE DRAWINGS

Exemplary embodiments of the present invention will be described in detail based on the following figures, wherein:

FIG. 1 is a schematic configuration diagram illustrating an image forming apparatus;

FIG. 2 is a diagram illustrating a configuration example of hardware of a control unit;

FIG. 3 is a diagram of a loading unit as viewed from above;

FIGS. 4A and 4B are diagrams illustrating processing for acquiring an adjustment time;

FIG. 5 is a diagram illustrating another example of processing for acquiring an adjustment time;

FIGS. 6A and 6B are diagrams illustrating processing for acquiring a blowing time;

FIG. 7 is a diagram illustrating an example of specific processing;

FIG. 8 is a diagram illustrating another example of adjustment processing and gas blowing processing;

FIG. 9 is a diagram illustrating a processing example when an adjustment time is shorter than a blowing time;

FIG. 10 is a diagram illustrating a processing example when a time difference between the adjustment time and the blowing time is within a predetermined range;

FIG. 11 is a flowchart illustrating a flow of a series of processing;

FIGS. 12A and 12B are diagrams describing processing when the adjustment time becomes long; and

FIG. 13 is a diagram illustrating another processing example.

### DETAILED DESCRIPTION

Hereinafter, an exemplary embodiment of the present invention will be described with reference to the accompanying drawings.

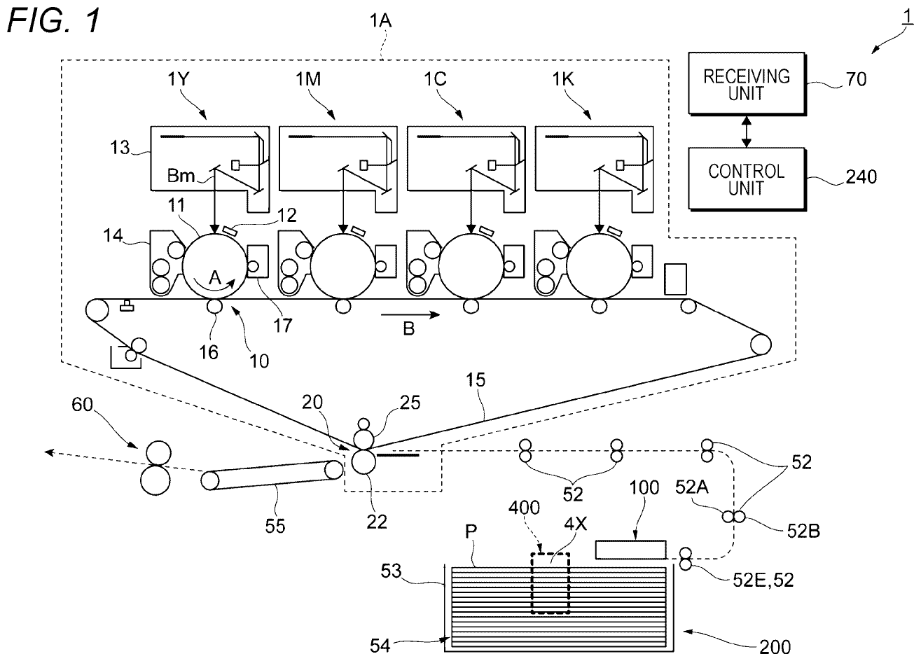

FIG. 1 is a schematic configuration diagram illustrating an image forming apparatus 1 according to the exemplary embodiment.

The image forming apparatus 1 illustrated in FIG. 1 is an image forming apparatus of an intermediate transfer method called a tandem type. The image forming apparatus 1 is provided with an image forming unit 1A that forms an image on a sheet P which is an example of a recording medium.

In the exemplary embodiment, as described later, adjustment processing on the image forming unit 1A is performed before image formation processing on the sheet P is started.

The image forming apparatus 1 is provided with a loading unit 200 on which the sheet P is loaded. The image formed by the image forming unit 1A is transferred onto the sheet P sent from the loading unit 200. An image is thus formed on the sheet P.

In the image forming unit 1A as an example of an image forming means, a plurality of image formation units 1Y, 1M, 1C, and 1K with which toner images of respective color components are formed in an electrophotographic method are provided.

The image forming unit 1A is provided with a primary transfer unit 10 that sequentially transfers the toner images in respective colors formed by the respective image formation units 1Y, 1M, 1C, and 1K onto an intermediate transfer belt 15.

The image forming unit 1A is also provided with a secondary transfer unit 20 that collectively transfers the superimposed toner images transferred on the intermediate transfer belt 15 onto the sheet P.

The image forming apparatus 1 is provided with a fixing device 60 that fixes the toner image secondarily transferred on the sheet P.

Further, the image forming apparatus 1 is provided with a control unit 240 that controls the operation of each unit of the image forming apparatus 1 and a receiving unit 70 that receives information input by the user.

The receiving unit 70 is constituted by, for example, a touch panel. The receiving unit 70 has a display function of displaying information in addition to a reception function of receiving information from the user.

A device for achieving the reception function and a device for achieving the display function may be separately provided.

### Configuration of Control Unit

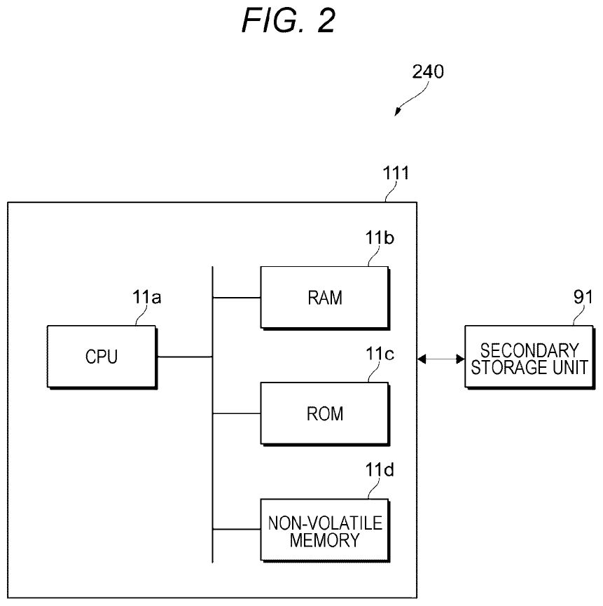

FIG. 2 is a diagram illustrating a configuration example of hardware of the control unit 240. The control unit 240 is implemented by a computer.

The control unit 240 includes an arithmetic processing unit 111 that executes digital arithmetic processing in accordance with a program, and a secondary storage unit 91 that stores information.

The secondary storage unit 91 is implemented by an existing information storage device, for example, a hard disk drive (HDD), a semiconductor memory, or a magnetic tape.

The arithmetic processing unit 111 is provided with a CPU 11a as an example of a processor.

The arithmetic processing unit 111 is also provided with a RAM 11b used as a working memory or the like of the CPU 11a and a ROM 11c in which a program or the like to be executed by the CPU 11a is stored.

The arithmetic processing unit 111 is also provided with a non-volatile memory 11d that is configured to be rewritable and can retain date even when power supply is stopped.

The non-volatile memory 11d includes, for example, a battery-backed SRAM, a flash memory, or the like. The secondary storage unit 91 stores various information such as a program to be executed by the arithmetic processing unit 111.

In the exemplary embodiment, the CPU 11a of the arithmetic processing unit 111 reads a program stored in the ROM 11c or the secondary storage unit 91 to execute various types of processing performed in the image forming apparatus 1.

The program to be executed by the CPU 11a may be provided to the image forming apparatus 1 in a state of being stored in a computer-readable recording medium such as a magnetic recording medium (magnetic tape, magnetic disk, or the like), an optical recording medium (optical disc or the like), a magneto-optical recording medium, or a semiconductor memory. The program to be executed by the CPU 11a may be provided to the image forming apparatus 1 by using a communication means such as the Internet.

In the specification, the processor refers to a processor in a broad sense, and includes general-purpose processors (e.g., central processing unit (CPU)) and dedicated processors (e.g., graphics processing unit (GPU), application specific integrated circuit (ASIC), field programmable gate array (FPGA), programmable logic devices).

The operation of the processor may be performed not only by one processor but also by a plurality of processors that are present at physically distant positions in cooperation with each other. The order of the operations of the processor is not limited to only the order described in the exemplary embodiment and may be changed.

The image forming apparatus 1 will be further described with reference to FIG. 1.

In each of the image formation units 1Y, 1M, 1C, and 1K, the following devices are installed.

First, a charging device 12 that charges a photoreceptor drum 11 is provided around the photoreceptor drum 11 that rotates in a direction of the arrow A. An exposure device 13 for writing an electrostatic latent image on the photoreceptor drum 11 is also provided. Further, a developing device 14 that develops the electrostatic latent image on the photoreceptor drum 11 with toner is provided.

Each of the image formation units 1Y, 1M, 1C, and 1K is provided with a primary transfer roller 16 that transfers a corresponding color component toner image formed on the photoreceptor drum 11 to the intermediate transfer belt 15 in the primary transfer unit 10.

Each of the image formation units 1Y, 1M, 1C, and 1K is also provided with a drum cleaner 17 that removes residual toner and the like on the photoreceptor drum 11.

The intermediate transfer belt 15 circulates at a predetermined speed in the direction of the arrow B illustrated in FIG. 1.

The primary transfer unit 10 includes a primary transfer roller 16 disposed opposite the photoreceptor drum 11 with the intermediate transfer belt 15 therebetween.

In the exemplary embodiment, the toner images on the respective photoreceptor drums 11 are sequentially and electrostatically attracted to the intermediate transfer belt 15, and superimposed toner images are formed on the intermediate transfer belt 15.

The secondary transfer unit 20 includes a secondary transfer roller 22 disposed opposite the outer peripheral surface of the intermediate transfer belt 15, and a backup roller 25.

The secondary transfer roller 22 is pressed against the backup roller 25 with the intermediate transfer belt 15 interposed therebetween. Further, a voltage is applied between the secondary transfer roller 22 and the backup roller 25. In the exemplary embodiment, the toner images on the intermediate transfer belt 15 are transferred onto the sheet P conveyed to the secondary transfer unit 20.

In the exemplary embodiment, image data is output from an image reading device, a personal computer (PC), or the like (not illustrated) to the image forming apparatus 1.

Then, image processing is performed on the image data by an image processing apparatus (not illustrated), and image data in four colors of Y, M, C, and K is generated. The generated image data is output to the exposure devices 13 provided for the respective colors of Y, M, C, and K.

The exposure device 13 irradiates the photoreceptor drum 11 of each of the image formation units 1Y, 1M, 1C, and 1K with an exposure beam Bm emitted from, for example, a semiconductor laser according to input image data.

The exposure of the photoreceptor drum 11 with the exposure device 13 is not limited to the exposure using the semiconductor laser, and the exposure of the photoreceptor drum 11 may be performed using light emitted from a light emitting diode (LED).

After the surface of each photoreceptor drum 11 is charged by the charging device 12, the surface is scanned and exposed by the exposure device 13 to form an electrostatic latent image.

Then, after toner images are formed on the photoreceptor drum 11 by the developing device 14, the toner images are transferred onto the intermediate transfer belt 15 in the primary transfer unit 10 where the photoreceptor drum 11 and the intermediate transfer belt 15 are in contact with each other.

After the toner images are sequentially and primarily transferred to the surface of the intermediate transfer belt 15, the toner images move to the secondary transfer unit 20 with the movement of the intermediate transfer belt 15.

In the secondary transfer unit 20, the secondary transfer roller 22 is pressed against the backup roller 25 with the intermediate transfer belt 15 interposed therebetween.

In the exemplary embodiment, the sheet P conveyed from the loading unit 200 is nipped between the intermediate transfer belt 15 and the secondary transfer roller 22.

This causes the unfixed toner images held on the intermediate transfer belt 15 to be collectively and electrostatically transferred onto the sheet P in the secondary transfer unit 20. Thereafter, the sheet P on which the toner image is transferred passes through the fixing device 60 and is discharged to a sheet discharge unit (not illustrated).

### Description on Blowing Device

The loading unit 200 is provided with a storage portion 53 that stores the sheets P to be loaded. The storage portion 53 is provided with a support base that supports the sheet P from below, a side guide that abuts against a side edge of the sheet P and is used for positioning of the sheet P, and the like.

In the exemplary embodiment, the uppermost sheet P of the sheets P loaded in the loading unit 200 is fed. In the exemplary embodiment, a sheet bundle 54 is formed by a plurality of sheets P loaded on the loading unit 200, and the uppermost sheet P of the sheets P included in the sheet bundle 54 is fed.

Then, in the secondary transfer unit 20, the toner image formed by the image forming unit 1A is transferred onto the fed sheet P.

Further, in the exemplary embodiment, a blowing device 400 that blows a gas onto the sheet P loaded on the loading unit 200 is provided.

In the exemplary embodiment, the blowing of gas onto the sheet P loaded on the loading unit 200 is performed by the blowing device 400 as an example of a blowing means.

With this configuration, in the exemplary embodiment, the amount of moisture contained in the sheet P decreases, gas enters between the sheets P, and thus so-called double feed in which a plurality of sheets P are fed in a state of being superimposed on each other is less likely to occur.

In the exemplary embodiment, air is blown as the gas. The type of the gas is not particularly limited, and a gas other than air may be blown onto the sheet P.

The blowing device 400 may be provided with a heater serving as a heating source. In this case, a heated gas is blown to the sheets P loaded on the loading unit 200.

Further, in the exemplary embodiment, a suction unit 100 that sucks the sheets P constituting the sheet bundle 54 is provided above the sheet bundle 54.

Further, a plurality of conveyance rollers 52 that convey the sheet P sent out from the loading unit 200 are provided on the downstream side from the loading unit 200 in the conveyance direction of the sheet P.

Each of the conveyance rollers 52 includes a drive roller 52A that rotates by receiving a driving force from a motor (not illustrated), and a driven roller 52B that is disposed in contact with the drive roller 52A and rotates by receiving a driving force from the drive roller 52A.

In the exemplary embodiment, the sheet P fed from the loading unit 200 is first conveyed by the conveyance roller 52 located on the most upstream side in the conveyance direction of the sheet P (hereinafter, referred to as “most upstream conveyance roller 52E”) among the plurality of conveyance rollers 52.

Then, the sheet P is further conveyed by another conveyance roller 52 located on the downstream side relative to the most upstream conveyance roller 52E, and heads for the secondary transfer unit 20 and the fixing device 60.

Further, a conveyance belt 55 is provided on the downstream side of the secondary transfer roller 22 in the conveyance direction of the sheet P. The conveyance belt 55 conveys the sheet P on which the secondary transfer has been performed to the fixing device 60.

The suction unit 100 sucks and holds the uppermost sheet P among the sheets P loaded in the loading unit 200. In other words, the suction unit 100 sucks and holds the uppermost sheet P among the sheets P constituting the sheet bundle 54.

Then, the suction unit 100 moves toward the most upstream conveyance roller 52E while holding the sheet P, and delivers the sheet P to the most upstream conveyance roller 52E.

The conveyance of the sheet P by the most upstream conveyance roller 52E thus starts.

After having delivered the sheet P to the most upstream conveyance roller 52E, the suction unit 100 moves in a direction away from the most upstream conveyance roller 52E and returns to the initial position.

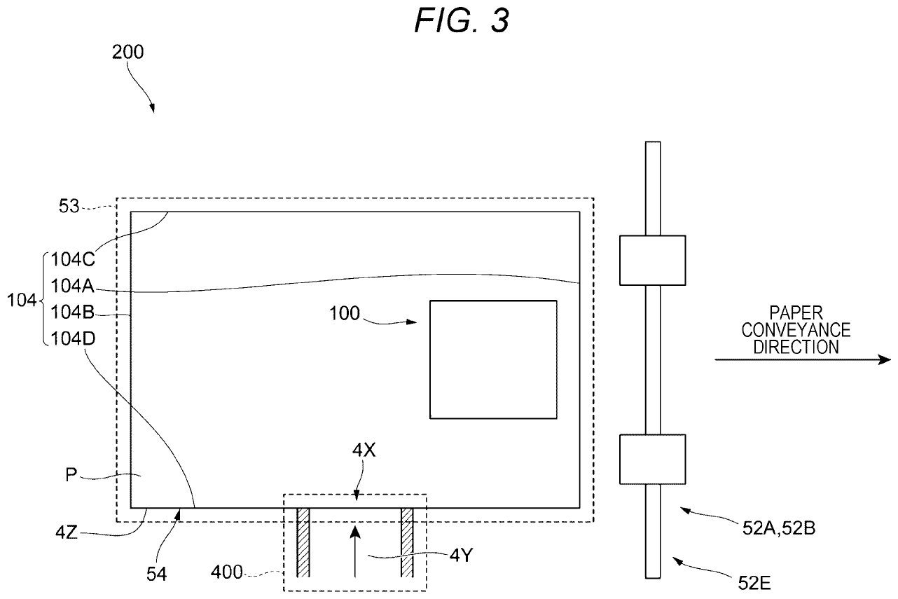

FIG. 3 is a diagram of the loading unit 200 as viewed from above.

In the exemplary embodiment, the sheet bundle 54 is brought into a state of being placed on the loading unit 200. The sheet bundle 54 and each sheet P included in the sheet bundle 54 have a rectangular outer peripheral edge 104.

The rectangular outer peripheral edge 104 includes a front-end-side outer peripheral edge 104A, a rear-end-side outer peripheral edge 104B, a first-side outer peripheral edge 104C, and a second-side outer peripheral edge 104D.

The front-end-side outer peripheral edge 104A is the outer peripheral edge 104 located on the most downstream side in the conveyance direction of the sheet P. The front-end-side outer peripheral edge 104A extends along a direction intersecting (orthogonal to) the conveyance direction of the sheet P.

The rear-end-side outer peripheral edge 104B is the outer peripheral edge 104 located on the most upstream side in the conveyance direction of the sheet P. The rear-end-side outer peripheral edge 104B also extends along a direction intersecting (orthogonal to) the conveyance direction of the sheet P.

The first-side outer peripheral edge 104C is an outer peripheral edge 104 connecting one end of the front-end-side outer peripheral edge 104A and one end of the rear-end-side outer peripheral edge 104B. The first-side outer peripheral edge 104C extends along the conveyance direction of the sheet P.

The second-side outer peripheral edge 104D is an outer peripheral edge 104 connecting the other end of the front-end-side outer peripheral edge 104A and the other end of the rear-end-side outer peripheral edge 104B. The second-side outer peripheral edge 104D also extends along the conveyance direction of the sheet P.

In the exemplary embodiment, the blowing device 400 is brought into a state of being positioned on a side of the sheet bundle 54 placed in the loading unit 200. In the exemplary embodiment, the blowing device 400 is located at a position facing the second-side outer peripheral edge 104D of the sheet bundle 54 placed on the loading unit 200.

The sheet bundle 54 has a rectangular parallelepiped shape and has four side surfaces, and the blowing device 400 is located at a position facing one of the four side surfaces.

Specifically, the blowing device 400 is located at a position opposed to one side surface indicated by the reference numeral 4Z along the feeding direction of the sheet P fed from the loading unit 200 among the four side surfaces.

The installation position of the blowing device 400 is not limited to this, and the blowing device 400 may be provided at a position opposed to the first-side outer peripheral edge 104C, a position opposed to the front-end-side outer peripheral edge 104A, a position opposed to the rear-end-side outer peripheral edge 104B, or the like.

In other words, the blowing device 400 may be provided at a position opposed to another side surface other than the one side surface indicated by the reference numeral 4Z among the above-described four side surfaces.

The number of blowing positions that are positions on the sheet bundle 54 to which air is blown by the blowing device 400 is not limited to one, and may be two or more.

The blowing device 400 is provided with an air supply source (not illustrated) such as a fan, a discharge port 4X from which air from the air supply source is discharged, and a channel 4Y that connects the air supply source and the discharge port 4X.

The number of discharge ports 4X is not particularly limited, and may be one or more. When a plurality of discharge ports 4X are provided, the number of blowing positions on the sheet bundle 54 to which air is blown by the blowing device 400 is two or more.

In the exemplary embodiment, the air is sent from the discharge port 4X toward a side surface of the sheet bundle 54, and the air is blown to the side surface.

More specifically, in the exemplary embodiment, as illustrated in FIG. 1, the discharge port 4X is configured to face an upper portion of the sheet bundle 54. Thus, in the exemplary embodiment, the blowing device 400 blows a gas on the upper portion of the sheet bundle 54 placed in the loading unit 200.

When the gas is blown to the side surface of the sheet bundle 54, air enters between the sheets P constituting the sheet bundle 54.

In the exemplary embodiment, when the upper surface of the sheet bundle 54 becomes lower with the feeding of the sheet P from the loading unit 200, the support base (not illustrated) supporting the sheet P from below moves upward.

Thus, the sheet P to which the gas has not been blown is positioned at the place facing the discharge port 4X. In this case, the gas is blown to the sheet P to which the gas has not been blown yet.

### Adjustment Processing on Image Forming Unit, Gas Blowing Processing Onto Sheet

In the exemplary embodiment, adjustment processing on the image forming unit 1A (see FIG. 1) is performed before image formation processing on the sheet P is started.

In the exemplary embodiment, before image formation processing on the sheet P is started, gas blowing processing by the blowing device 400 is performed on the sheet P loaded on the loading unit 200.

In other words, in the exemplary embodiment, before the conveyance of the sheet P is started, the adjustment processing on the image forming unit 1A is performed, and the gas blowing processing of onto the sheet P is performed.

Then, after the adjustment processing and the blowing processing are completed, the conveyance of the sheet P is started, and the image formation processing on the sheet P is started.

The adjustment processing on the image forming unit 1A is performed to ensure the quality of the image to be formed on the sheet P.

The adjustment processing includes, for example, adjustment processing for setting the density of an image to be formed to a specified value, adjustment processing for setting the color of an image to be formed to a specified color, and adjustment processing for setting the formation position of an image to be formed to a specified position.

More specifically, in the adjustment processing, first, the image forming unit 1A is driven.

More specifically, in the adjustment processing, first, each of the image formation units 1Y, 1M, 1C, and 1K is activated to form a toner image on the intermediate transfer belt 15, for example.

Then, a sensor (not illustrated) is used to acquire information on the toner image on the intermediate transfer belt 15.

Specifically, as the information on the toner image, information on the density, color, formation position, and the like of the toner image is acquired. Then, based on the acquired information, a parameter used for image formation is changed.

Thus, the density, color, and formation position of the image to be formed on the sheet P are brought closer to the originally intended states.

In the gas blowing processing onto the sheet P, as described above, the gas blowing is performed on a side of the sheet bundle 54.

Thus, the moisture contained in the sheets P constituting the sheet bundle 54 decreases, and the gas enters between the sheets P. This causes so-called double feed in which a plurality of sheets P are fed in a state of being superimposed on each other is less likely to occur.

### Processing for Setting Blowing Start Timing

In the exemplary embodiment, first, the CPU 11a as an example of a processor acquires an adjustment time that is a time during which the above-described adjustment processing is performed on the image forming unit 1A and a blowing time that is a time during which the above-described gas blowing processing is performed.

Then, based on the obtained adjustment time and blowing time, the CPU 11a sets the blowing start timing, which is the timing of starting the blowing of the gas with the blowing device 400.

The adjustment time that is the time during which the adjustment processing on the image forming unit 1A is performed can be regarded as the time required for the adjustment processing, and the time during which the gas blowing processing is performed can be regarded as the time required for the gas blowing processing.

The CPU 11a sets the blowing start timing based on the time required for the adjustment processing on the image forming unit 1A and the time required for the gas blowing processing.

In the setting of the blowing start timing, as described above, the CPU 11a first acquires the adjustment time, which is the time during which the adjustment processing for the image forming unit 1A is performed, and the blowing time, which is the time during which the gas blowing processing is performed.

Then, the CPU 11a sets the gas blowing start timing based on the obtained adjustment time and blowing time.

### Processing for Acquiring Adjustment Time

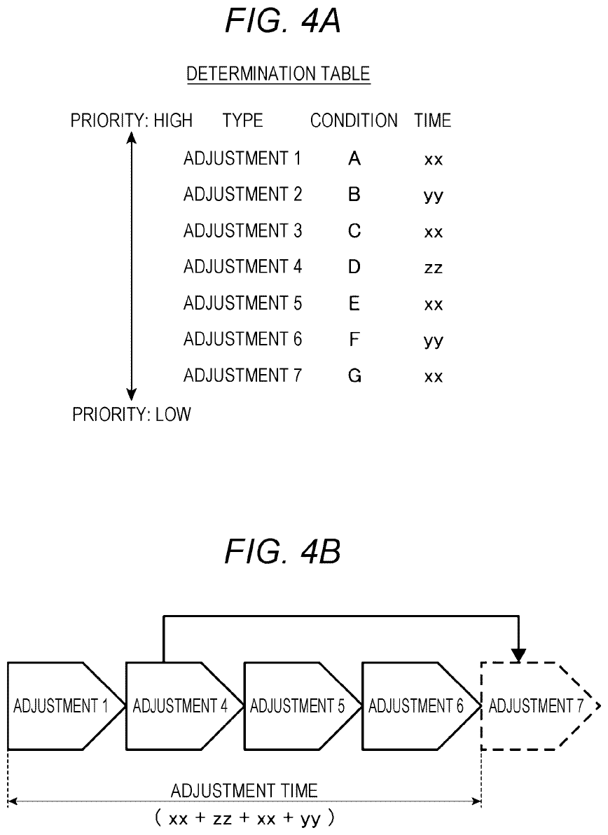

FIGS. 4A and 4B are diagrams illustrating processing for acquiring an adjustment time.

In the exemplary embodiment, a determination table illustrated in FIG. 4A is stored in the secondary storage unit 91 (see FIG. 2), which is an example of an information storage unit. When acquiring the adjustment time for the image forming unit 1A, the CPU 11a acquires the adjustment time with reference to the determination table.

Specifically, the CPU 11a determines whether the configuration of the image forming unit 1A and the sheets P loaded in the loading unit 200 correspond to each of the conditions A to G in FIG. 4A, and when so, acquires the time associated with the corresponding condition. Then, the CPU 11a adds the acquired times, and acquires the addition result as the adjustment time.

For example, when the configuration of the image forming unit 1A and the sheets P loaded on the loading unit 200 correspond to the conditions A, D, E and F, a time obtained by adding the time xx, the time zz, the time xx, and the time yy is obtained as the adjustment time.

In the exemplary embodiment, when the configuration of the image forming unit 1A and the sheets P loaded on the loading unit 200 correspond to the conditions A, D, E, and F, as illustrated in FIG. 4B, Adjustment 1, Adjustment 4, Adjustment 5, and Adjustment 6 are performed in order as the adjustment processing.

In the exemplary embodiment, another additional piece of processing may be performed according to the result of one piece of processing included in the adjustment processing.

Specifically, when a result of the one piece of processing acquired by a sensor (not illustrated) satisfies a predetermined condition, another additional piece of processing may be performed. In this case, the adjustment time becomes longer than the initial adjustment time.

In the example illustrated in FIG. 4B, a case where Adjustment 7 is additionally performed in accordance with the result of Adjustment 4 is illustrated, and when Adjustment 7 is performed, the adjustment time becomes longer than the adjustment time initially acquired by the CPU 11a.

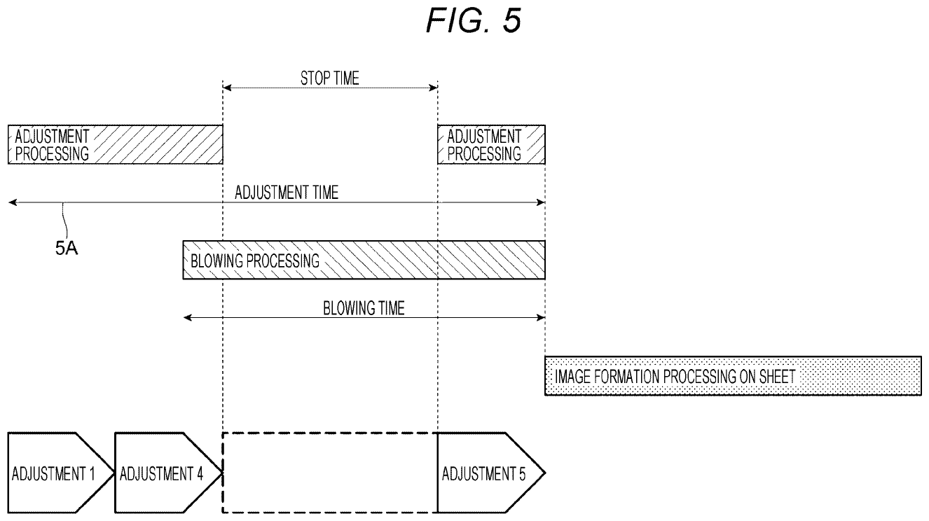

FIG. 5 is a diagram illustrating another example of processing for acquiring the adjustment time.

In the exemplary embodiment, in the acquisition of the adjustment time, a stop time that is a time during which the adjustment processing is not performed is also acquired as the adjustment time. In the example illustrated in FIG. 5, the time indicated by the reference numeral 5A is acquired as the adjustment time.

In the adjustment processing, the driving of the image forming unit 1A may be restarted after being temporarily stopped. In the exemplary embodiment, in this case, the time from the stop of the driving of the image forming unit 1A to the restart of the driving of the image forming unit 1A is also acquired as the adjustment time.

In the example illustrated in FIG. 5, a case where driving of the image forming unit 1A is temporarily stopped after Adjustment 4 is illustrated. Here, for example, to perform Adjustment 5, it may be necessary to temporarily stop the driving of the image forming unit 1A, and in this case, as illustrated in FIG. 5, after Adjustment 4, the driving of the image forming unit 1A is temporarily stopped.

In the exemplary embodiment, in this case, even when the driving of the image forming unit 1A is stopped, it is considered that the adjustment processing is being performed. In the exemplary embodiment, the time from the start of Adjustment 1 to the end of Adjustment 5 is acquired as the adjustment time without excluding the time during which the driving of the image forming unit 1A is stopped.

Even when the driving of the image forming unit 1A is stopped, it is considered that the adjustment processing is being performed, and when the adjustment time is acquired including the time during which the image forming unit 1A is stopped, the start of the image formation processing on the sheet P is less likely to delay.

In the exemplary embodiment, as described later, the adjustment processing and the blowing processing are performed in parallel, and thus the image formation processing onto the sheet P is started earlier as compared with a case where they are not performed in parallel.

Here, for example, it is also conceivable to regard the time period during which the driving of the image forming unit 1A is stopped as a time period during which the adjustment processing is not performed, and perform processing in which the gas blowing processing is not performed during the time period during which the driving of the image forming unit 1A is stopped.

In this case, the timing of ending the blowing of the gas is delayed, and the timing of starting the image formation processing onto the sheet P delays correspondingly.

When the gas blowing processing is not performed during the time when the driving of the image forming unit 1A is stopped, it is necessary to delay the end timing of the gas blowing to secure the amount of the gas blown onto the sheet P. In this case, the timing of starting the image formation processing onto the sheet P delays correspondingly.

In contrast, when the blowing processing is performed while the adjustment processing is considered to be performed even during the time when the driving of the image forming unit 1A is stopped, a situation in which the timing of starting the image formation processing onto the sheet P is delayed is less likely to occur.

### Processing for Acquiring Blowing Time

Next, the processing for acquiring blowing time will be described.

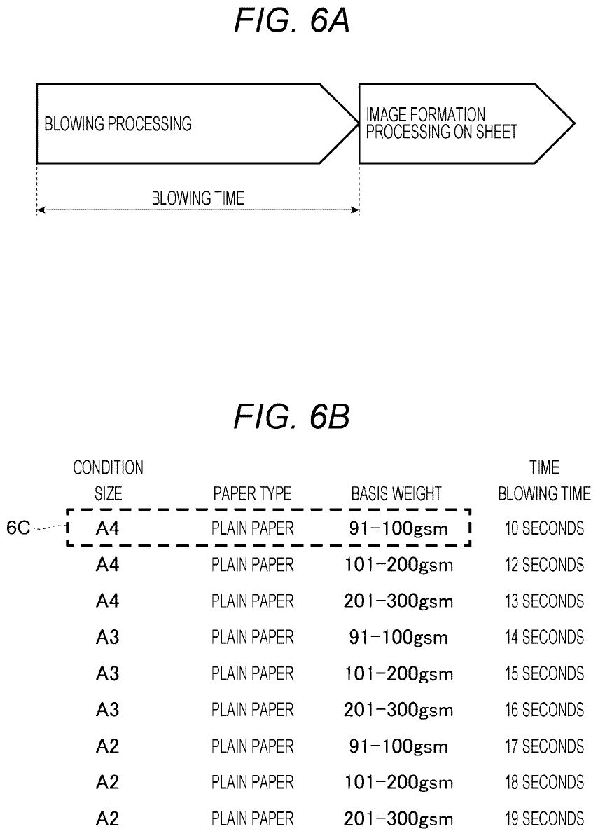

FIGS. 6A and 6B are diagrams illustrating processing for acquiring the blowing time.

In the exemplary embodiment, as illustrated in FIG. 6A, the gas blowing processing onto the sheet P is performed before the image formation processing on the sheet P starts. In the exemplary embodiment, basically, after the blowing of the gas onto the sheet P is completed, the image formation processing onto the sheet P starts.

In the exemplary embodiment, the CPU 11a acquires a blowing time that is a time during which the blowing of the gas onto the sheet P is performed.

The CPU 11a acquires information on the basis weight, size, and paper type of the sheet P loaded in the loading unit 200 and information on setting values that are values set by the user. Then, the CPU 11a acquires the blowing time based on the acquired information.

The information on the basis weight, size, and paper type of the sheet P and the information on the setting value set by the user are input to the image forming apparatus 1 by the user via the receiving unit 70 (see FIG. 1), for example.

Based on these pieces of information input by the user, the CPU 11a acquires information about the basis weight, size, and paper type of the sheet P and information about the setting values set by the user.

FIG. 6B illustrates a specific example.

For example, when the user inputs information indicated by the reference numeral 6C in FIG. 6B, the CPU 11a acquires information indicating that the size of the sheet P is A4, the paper type of the sheet P is plain paper, and the basis weight of the sheet P is 91-100 gsm. Then, in this case, the CPU 11a acquires the blowing time based on these pieces of information.

Specifically, in this case, the CPU 11a acquires, as the blowing time, “10 seconds” associated with these pieces of information.

When there are a plurality of loading unit 200 in the image forming apparatus 1, the CPU 11a acquires the blowing time for each loading unit 200.

### Description of Specific Processing

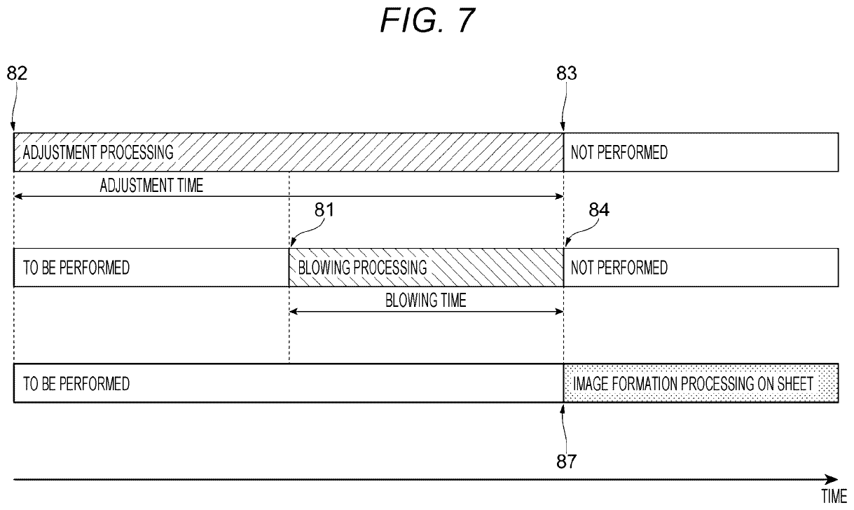

FIG. 7 is a diagram illustrating an example of specific processing.

After acquiring the adjustment time and the blowing time, the CPU 11a sets the blowing start timing based on the acquired adjustment time and blowing time.

As illustrated in FIG. 7, when the adjustment time is longer than the blowing time, the CPU 11a sets a blowing start timing 81 such that the blowing start timing 81 is temporally later than an adjustment processing start timing 82 that is the timing at which the adjustment processing starts.

In other words, the CPU 11a sets the blowing start timing 81 such that the blowing start timing 81 is later than the adjustment processing start timing 82.

Thus, in the exemplary embodiment, a situation in which the sheet P absorbs moisture again or the like is unlikely to occur.

Here, for example, a case is assumed where the blowing start timing 81 is the same as the adjustment processing start timing 82. Specifically, a case is assumed where the blowing start timing 81 is temporally earlier than the blowing start timing 81 illustrated in FIG. 7 and the blowing start timing 81 is the same as the adjustment processing start timing 82.

In this case, the gas blowing processing ends before an adjustment processing end timing 83 that is the timing at which the adjustment processing ends. In this case, the sheet P may absorb moisture again during a period from the end of the blowing of the gas to the start of the image formation processing on the sheet P.

In contrast, in the configuration in which the blowing start timing 81 is temporally later than the adjustment processing start timing 82 as in the exemplary embodiment, the time period from the end of the blowing of the gas to the start of the image formation processing on the sheet P is shorter than in the case where the blowing start timing 81 is the same as the adjustment processing start timing 82.

In this case, a situation in which the sheet P absorbs moisture again is less likely to occur, or even though the sheet P absorbs moisture again, the amount of moisture absorption is small.

In the image forming apparatus 1 of the exemplary embodiment, the adjustment processing on the image forming unit 1A is the reference of the processing, and when the adjustment time is acquired, first, the adjustment processing start timing 82 is determined, and next, the start timing 87 of the image formation processing on the sheet P (hereinafter, referred to as the “image formation start timing 87”) is determined.

In the exemplary embodiment, the image formation start timing 87 is determined such that the image formation processing onto the sheet P starts after a predetermined time has elapsed from the adjustment processing end timing 83 that is the ending timing of the adjustment processing.

Thereafter, in the exemplary embodiment, the CPU 11a compares the magnitudes of the adjustment time and the blowing time based on the acquired adjustment time and blowing time.

Then, when the adjustment time is longer than the blowing time, the CPU 11a sets the blowing start timing 81 such that the blowing start timing 81 comes later than the adjustment processing start timing 82.

In the processing example illustrated in FIG. 7, the CPU 11a sets the blowing start timing 81 such that a time difference between the blowing end timing 84 and the adjustment processing end timing 83 falls within a predetermined range.

The blowing end timing 84 refers to a timing at which the blowing processing ends. The adjustment processing end timing 83 indicates a timing at which the adjustment processing ends.

In this processing example illustrated in FIG. 7, the CPU 11a sets the blowing start timing 81 so as to reduce the time lag between the blowing end timing 84 and the adjustment processing end timing 83.

In setting the blowing start timing 81, the blowing start timing 81 may be simply set such that the blowing start timing 81 comes later than the adjustment processing start timing 82.

On the other hand, as described above, when the blowing start timing 81 is set such that the time difference falls within the predetermined range, a situation in which the sheet P absorbs moisture again is less likely to occur than when the time difference does not fall within the predetermined range and the blowing end timing 84 is temporally earlier than the adjustment processing end timing 83.

To keep the time difference within the predetermined range, it is more preferable to set the blowing start timing 81 such that the blowing end timing 84 and the adjustment processing end timing 83 coincide with each other.

In other words, to make the time difference fall within the predetermined range, it is more preferable to set the blowing start timing 81 such that the blowing end timing 84 and the adjustment processing end timing 83 are the same.

### Another Example of Adjustment Processing and Gas Blowing Processing

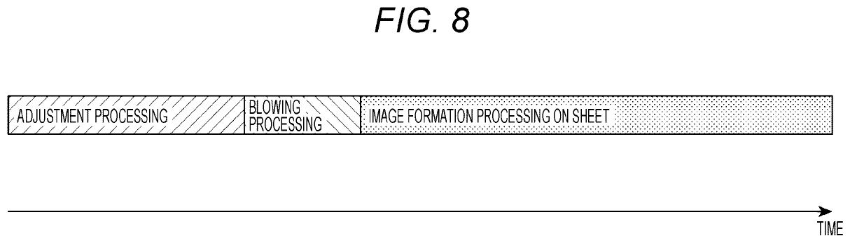

FIG. 8 is a diagram illustrating another example of the adjustment processing and the gas blowing processing.

In the processing illustrated in FIG. 7, the adjustment processing and the blowing processing are performed in parallel.

In contrast, in the processing illustrated in FIG. 8, the blowing processing is performed after the adjustment processing is performed.

In this case, the adjustment processing and the blowing processing are performed in different time zones, and the time required until the image formation processing on the sheet P starts is likely to be long.

In contrast, when the adjustment processing and the blowing processing are performed in parallel as in the processing illustrated in FIG. 7, the time required until the image formation processing onto the sheet P starts is shortened.

### Processing When Adjustment Time is Shorter Than Blowing Time

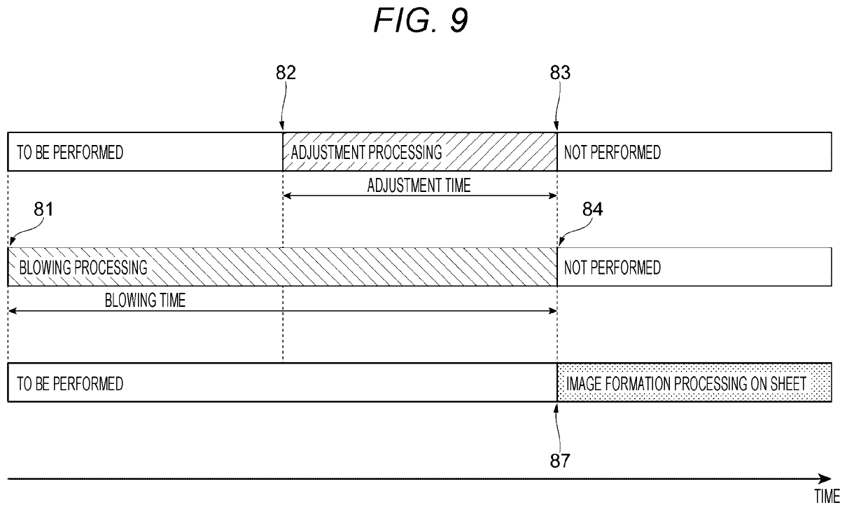

FIG. 9 is a diagram illustrating a processing example when the adjustment time is shorter than the blowing time.

In this case, the CPU 11a sets the blowing start timing 81 such that the blowing start timing 81 is temporally earlier than the adjustment processing start timing 82.

Here, it is assumed that the blowing start timing 81 is shifted backward in time from the blowing start timing 81 illustrated in FIG. 9, and the blowing start timing 81 is the same as the adjustment processing start timing 82.

When the blowing start timing 81 is set to be the same as the adjustment processing start timing 82, image formation processing on the sheet P starts while the gas blowing processing is still being performed.

In this case, the image formation processing on the sheet P starts in a state where the blowing of the gas onto the sheet P is insufficient.

On the other hand, as in the processing example illustrated in FIG. 9, when the blowing start timing 81 is set such that the blowing start timing 81 is earlier than the adjustment processing start timing 82, a state in which the blowing of the gas onto the sheet P is insufficient is unlikely to occur.

Further, in this processing example illustrated in FIG. 9, the CPU 11a sets the blowing start timing 81 such that the blowing end timing 84 is temporally later than the adjustment processing start timing 82.

Here, it is assumed that the blowing end timing 84 comes earlier than the adjustment processing start timing 82.

When the blowing end timing 84 is earlier than the adjustment processing start timing 82, the adjustment processing and the blowing processing are performed in different time zones. In this case, it takes a long time from the start of the blowing of the gas to the start of the image formation processing on the sheet P.

In addition, when the blowing end timing 84 comes earlier than the adjustment processing start timing 82, a situation in which the sheet P absorbs moisture again more easily occurs than when the blowing end timing 84 comes later than the adjustment processing start timing 82.

When the blowing end timing 84 is earlier than the adjustment processing start timing 82, the time from the end of the blowing processing to the start of the image formation processing on the sheet P is longer than when the blowing end timing 84 is later than the adjustment processing start timing 82. In this case, the sheet P is likely to absorb moisture again.

On the other hand, when the blowing end timing 84 is later than the adjustment processing start timing 82, the time from the end of the gas blowing processing to the start of the image formation processing on the sheet P is shortened, and the sheet P is less likely to absorb moisture again.

Further, in this processing example illustrated in FIG. 9, the CPU 11a sets the blowing start timing 81 such that a time difference between the blowing end timing 84 and the adjustment processing end timing 83 falls within a predetermined range.

Here, it is assumed that the time difference does not fall within the predetermined range and the blowing end timing 84 is temporally earlier than the adjustment processing end timing 83.

In this case, similarly to the above, during a period from ending of blowing of the gas onto the sheet P to starting of image formation processing onto the sheet P, the sheet P is more likely to absorb moisture, and the sheet P is more likely to absorb moisture again.

On the other hand, when the time difference falls within the predetermined range, the time from the end of the blowing processing on the sheet P to the start of the image formation processing on the sheet P is shortened, and the sheet P is less likely to absorb moisture again.

Similarly to the above, to make the time difference fall within the predetermined range, it is more preferable to set the blowing start timing 81 such that the blowing end timing 84 and the adjustment processing end timing 83 coincide with each other.

In other words, to make the time difference fall within the predetermined range, it is more preferable to set the blowing start timing 81 such that the blowing end timing 84 and the adjustment processing end timing 83 are the same.

### Processing When Time Difference is Within Predetermined Range

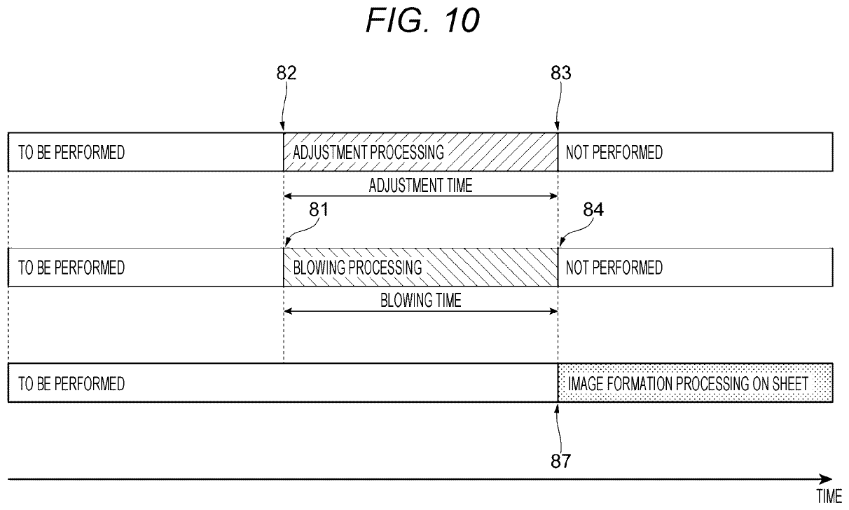

FIG. 10 is a diagram illustrating a processing example when a time difference between the adjustment time and the blowing time is within a predetermined range. In other words, FIG. 10 is a diagram illustrating a processing example when the adjustment time and the blowing time are equal or substantially equal.

When the time difference between the adjustment time and the blowing time is within a predetermined range, the CPU 11a sets the blowing start timing 81 such that the adjustment processing start timing 82 and the blowing start timing 81 coincide with each other.

In other words, when the time difference between the adjustment time and the blowing time is within the predetermined range, the CPU 11a sets the blowing start timing 81 such that the adjustment processing start timing 82 and the blowing start timing 81 become the same.

In this case, a time difference between the adjustment processing start timing 82 and the blowing start timing 81 becomes small, and a time difference between the adjustment processing end timing 83 and the blowing end timing 84 also becomes small.

In the exemplary embodiment, when the time difference between the adjustment time and the blowing time is outside the predetermined range, as illustrated in FIGS. 7 and 9, the CPU 11a sets the blowing start timing 81 such that the blowing start timing 81 is different from the adjustment processing start timing 82.

In this case, even when there is a time difference between the adjustment time and the blowing time, the time difference between the adjustment processing end timing 83 and the blowing end timing 84 becomes small.

When the time difference between the adjustment time and the blowing time is outside the predetermined range, as described above, it is more preferable to set the blowing start timing 81 such that the adjustment processing end timing 83 and the blowing end timing 84 coincide with each other.

### Description of Flow of Series of Processing

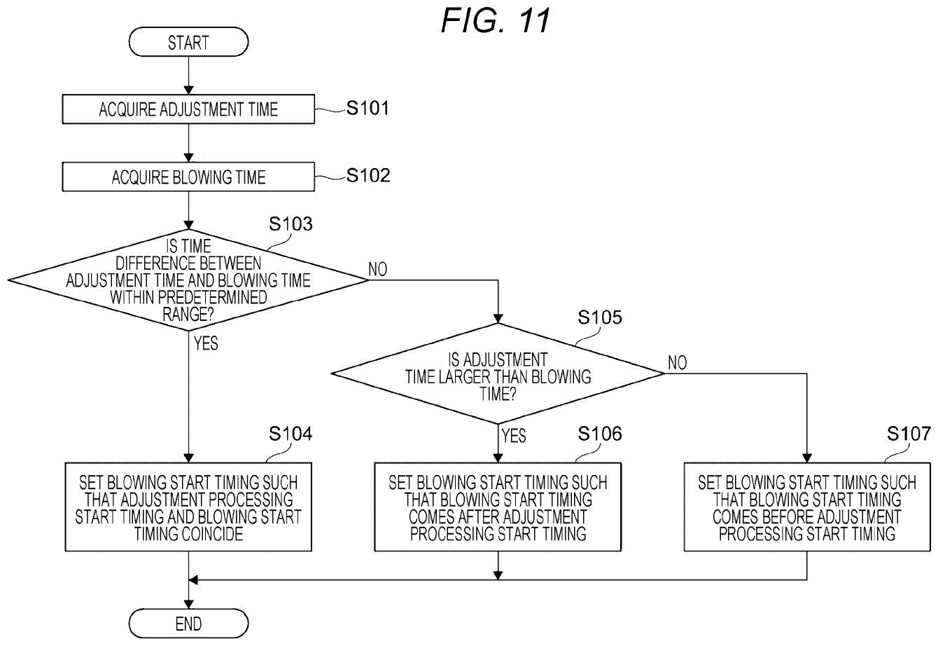

FIG. 11 is a flowchart illustrating a flow of a series of the processing described above.

In the exemplary embodiment, the CPU 11a first acquires the adjustment time (Step S101). Next, the CPU 11a acquires a blowing time (Step S102). Alternatively, the blowing time may be acquired first, and then the adjustment time may be acquired.

Next, the CPU 11a determines whether a time difference between the adjustment time and the blowing time is within a predetermined range (Step S103).

When the CPU 11a determines in Step S103 that the time difference is within the predetermined range, the CPU 11a sets the blowing start timing 81 such that the adjustment processing start timing 82 and the blowing start timing 81 coincide with each other (Step S104).

On the other hand, when the CPU 11a does not determine that the time difference is within the predetermined range in Step S104, the CPU 11a determines whether the adjustment time is longer than the blowing time (Step S105).

Next, when the CPU 11a determines in Step S105 that the adjustment time is longer than the blowing time, the CPU 11a sets the blowing start timing 81 such that the blowing start timing 81 comes later than the adjustment processing start timing 82 (Step S106).

On the other hand, when the CPU 11a does not determine in Step S105 that the adjustment time is longer than the blowing time, the CPU 11a sets the blowing start timing 81 such that the blowing start timing 81 is earlier than the adjustment processing start timing 82 (Step S107).

### Processing When Adjustment Time Becomes Long

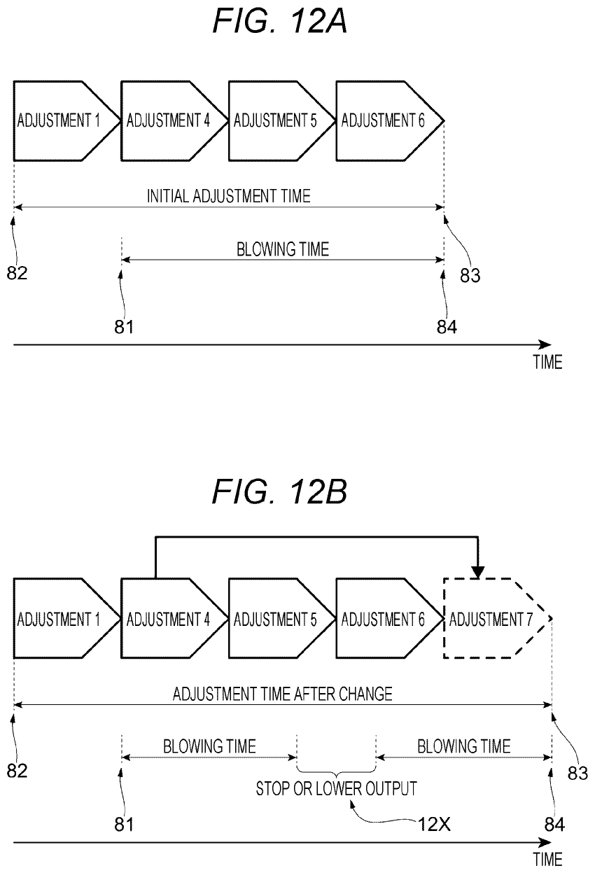

FIGS. 12A and 12B are diagrams describing processing when the adjustment time becomes long.

FIG. 12A illustrates an example of processing when the adjustment time does not become long, and FIG. 12B illustrates an example of processing when the adjustment time becomes long.

In the exemplary embodiment, as described above, the content of the adjustment processing may be changed during the adjustment processing, and accordingly, as illustrated in FIG. 12B, the adjustment time may become long.

More specifically, as described above, for example, another additional pieces of processing may be performed in accordance with the result of one piece of processing included in the adjustment processing, and in this case, the adjustment time becomes longer than the initial adjustment time.

In the exemplary embodiment, in this case, as illustrated in FIG. 12B, the CPU 11a delays the blowing end timing 84 that is a timing at which the gas blowing with the blowing device 400 ends.

When the blowing end timing 84 is delayed, the gas blowing processing onto the sheet P is performed until immediately before the image formation processing onto the sheet P starts, and a situation in which the sheet P absorbs moisture again is less likely to occur.

More preferably, in this case, the CPU 11a delays the blowing end timing 84 such that the adjustment processing end timing 83 (see FIG. 12B) after the time taken for the adjustment processing has become longer and the blowing end timing 84 coincide with each other.

Further, more preferably, in delaying the blowing end timing 84, the CPU 11a temporarily stops the gas blowing with the blowing device 400 or temporarily reduces the output of gas blowing with the blowing device 400, as indicated by the reference numeral 12X in FIG. 12B.

When the blowing end timing 84 is simply delayed, the total amount of gas blown onto the sheet P increases, and there is a concern that the sheet P will be excessively dried. When the sheet P is excessively dried, a problem such as deflection of the sheet P is likely to occur.

On the other hand, when the gas blowing is temporarily stopped or the output of the gas blowing is temporarily reduced, an increase in the total amount of the gas to be blown onto the sheet P is suppressed. In this case, a situation where the sheet P is excessively dried is less likely to occur.

### Setting of Adjustment Start Timing

The case where the CPU 11a sets the blowing start timing 81 has been described above as an example. The configuration is not limited to this, and it may be possible to adopt a configuration in which the CPU 11a sets the adjustment processing start timing 82 that is the timing at which the adjustment processing starts.

In this case, the CPU 11a sets the adjustment processing start timing 82 that is the timing at which the adjustment processing starts, based on the adjustment time and the blowing time.

Specifically, for example, as illustrated in FIG. 7, when the adjustment time is longer than the blowing time, the CPU 11a sets the adjustment processing start timing 82 such that the adjustment processing start timing 82 comes earlier than the blowing start timing 81.

In this case, it is more preferable to adopt a configuration in which the CPU 11a sets the adjustment processing start timing 82 such that the adjustment processing end timing 83 comes later than the blowing start timing 81.

In this case, it is more preferable to adopt a configuration in which the CPU 11a sets the adjustment processing start timing 82 such that the time difference between the blowing end timing 84 and the adjustment processing end timing 83 falls within a predetermined range.

Further, in this case, it is more preferable to adopt a configuration in which the CPU 11a sets the adjustment processing start timing 82 such that the blowing end timing 84 and the adjustment processing end timing 83 coincide with each other.

In the above, the case where the adjustment processing on the image forming unit 1A is the reference of the processing has been described, but it is also conceivable that the gas blowing processing is set as the reference of the processing.

In this case, when the blowing time is acquired, the blowing start timing 81 is determined, and then the image formation start timing 87 is determined.

In this case, the image formation start timing 87 is determined such that the image formation processing onto the sheet P is started after a predetermined time has elapsed from the blowing end timing 84.

Thereafter, in this case, the CPU 11a compares the magnitudes of the adjustment time and the blowing time based on the acquired adjustment time and blowing time.

As illustrated in FIG. 7, when the adjustment time is longer than the blowing time, the CPU 11a sets the adjustment processing start timing 82 such that the adjustment processing start timing 82 comes earlier than the blowing start timing 81.

In a case where the adjustment time is longer than the blowing time, when the adjustment processing start timing 82 is set, as described above, it is preferable to adopt a configuration in which the adjustment processing start timing 82 is set such that the adjustment processing end timing 83 comes later than the blowing start timing 81.

Here, when the adjustment processing end timing 83 comes earlier than the blowing start timing 81, the adjustment processing and the blowing processing are performed in different time zones, and the time required until image formation processing onto the sheet P starts becomes long.

When the adjustment processing end timing 83 comes earlier than the blowing start timing 81, a defect such as deterioration in quality of an image to be formed is likely to occur as compared to a case where the adjustment processing end timing 83 comes later than the blowing start timing 81.

When the adjustment processing end timing 83 comes earlier than the blowing start timing 81, the time period from the end of the adjustment processing to the start of the image formation processing onto the sheet P becomes long.

In this case, during a period from the end of the adjustment processing to the start of the image formation processing onto the sheet P, the state of the image forming unit 1A that has performed the adjustment processing is likely to change.

When the state of the image forming unit 1A is changed, a failure such as deterioration in quality of the image formed by the image forming unit 1A is likely to occur.

When the adjustment processing end timing 83 comes earlier than the blowing start timing 81 and a time period from the end of the adjustment processing to the start of the image formation processing onto the sheet P becomes long, there is also a risk that the quality of the formed image deteriorates due to the change in the environment around the image forming unit 1A.

When the time until the image formation processing onto the sheet P is started becomes long, an environment around the image forming unit 1A, such as humidity and temperature around the image forming unit 1A, is likely to change during the period from the end of the adjustment processing to the start of the image formation processing onto the sheet P.

In this case, a state in which the state of the image forming unit 1A is not suitable for the environment around the image forming unit 1A occurs, and a problem such as deterioration in quality of an image to be formed is likely to occur.

On the other hand, as described above, when the adjustment processing start timing 82 is set such that the adjustment processing end timing 83 comes later than the blowing start timing 81, the time until the image formation processing on the sheet P starts is shortened, and thus these disadvantages are unlikely to occur.

Further, in setting the adjustment processing start timing 82, as illustrated in FIG. 9, when the adjustment time is shorter than the blowing time, the CPU 11a sets the adjustment processing start timing 82 such that the adjustment processing start timing 82 comes later than the blowing start timing 81.

In this case as well, similarly to the above, the adjustment processing start timing 82 may be set such that the time difference between the blowing end timing 84 and the adjustment processing end timing 83 falls within a predetermined range.

Further, in this case, it is more preferable to set the adjustment processing start timing 82 such that the blowing end timing 84 and the adjustment processing end timing 83 coincide with each other.

### Processing for Setting Both Blowing Start Timing and Adjustment Processing Start Timing

In addition, the CPU 11a may perform the setting of both the blowing start timing 81 and the adjustment processing start timing 82.

The case where the start timing of one of the adjustment processing and the blowing processing serving as a reference is determined first, and then the CPU 11a sets the start timing of the other processing has been described above as an example.

The CPU 11a may set the start timing for one of the adjustment processing and the blowing processing, and then set the start timing for the other processing.

### Others

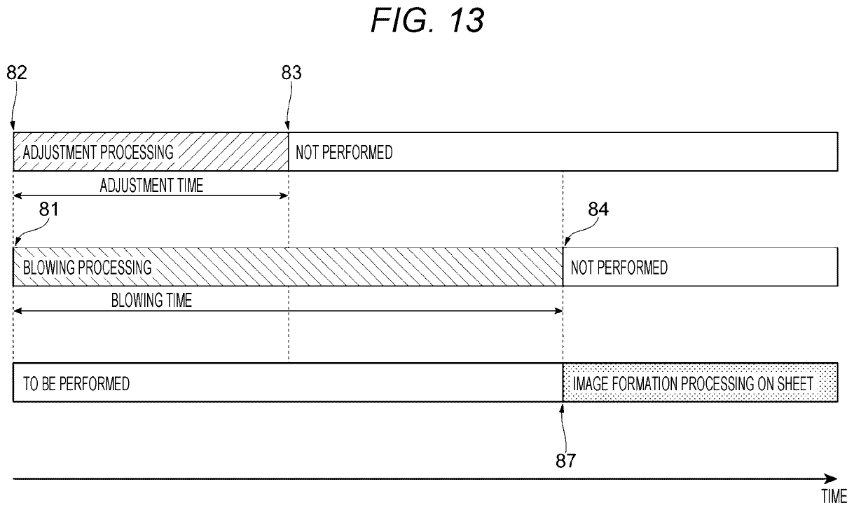

FIG. 13 is a diagram illustrating another processing example.

In the above, as illustrated in FIG. 9, the processing example in which the blowing start timing 81 comes earlier than the adjustment processing start timing 82 when the blowing time is longer than the adjustment time has been described as an example.

As another piece of processing, when the blowing time is longer than the adjustment time, the blowing start timing 81 and the adjustment processing start timing 82 may coincide with each other as illustrated in FIG. 13.

Even when the blowing start timing 81 and the adjustment processing start timing 82 coincide with each other, the adjustment processing and the blowing processing are performed in parallel.

In this case, the time required until the image formation processing on the sheet P starts is shorter than when the adjustment processing and the blowing processing are performed in different time zones.

In addition, as illustrated in FIG. 13, when the blowing start timing 81 and the adjustment processing start timing 82 coincide with each other, it is possible to simplify the setting of the start timing and the control when the adjustment processing or the blowing processing is actually performed as compared to a case where the blowing start timing 81 and the adjustment processing start timing 82 are different from each other.

In addition, each processing of the exemplary embodiment described above is not limited to the timing before the image formation processing on the sheet P starts, and may be performed in the middle of the image formation.

More specifically, each processing in the exemplary embodiment described above may be performed at a timing during the image formation processing on the sheet P and at a timing when the image formation processing on the sheet P is temporarily interrupted.

When the image formation processing onto the sheet P is continuously performed, switching of the loading unit 200 may be performed during the formation processing, and in this case, in the exemplary embodiment, the image formation processing onto the sheet P is temporarily interrupted, and then the adjustment processing and the blowing processing are performed.

At this time, in the same manner as described above, the adjustment time and the blowing time may be acquired, and one or both of the blowing start timing 81 and the adjustment processing start timing 82 may be set based on the acquired adjustment time and blowing time.

In addition to the above, also when a lower sheet P of the sheets P included in the sheet bundle 54 provided in the loading unit 200 is positioned at the top, the image formation processing onto the sheet P is temporarily interrupted, and then the adjustment processing and the blowing processing are performed in some cases.

Also at this time, the adjustment time and the blowing time may be acquired, and based on the acquired adjustment time and blowing time, one or both of the blowing start timing 81 and the adjustment processing start timing 82 may be set.

### Supplementary Note

(((1)))

An image forming apparatus comprising:
a loading unit on which a recording medium on which an image is to be formed is loaded;
an image forming unit that forms the image, on which adjustment processing is performed before image formation processing on a recording medium starts;
a blowing unit that blows gas onto the recording medium loaded on the loading unit before the image formation processing on the recording medium starts; and
a processor that sets, based on adjustment time that is a time in which the image forming unit is adjusted and blowing time that is a time in which the gas is blown, start timing of at least one of blowing start timing that is a timing at which blowing of the gas starts and adjustment processing start timing that is a timing at which the adjustment processing starts.

(((2)))

The image forming apparatus according to (((1))),
wherein when the adjustment time is longer than the blowing time, the processor sets the at least one of the start timings such that the blowing start timing comes later than the adjustment processing start timing.

(((3)))

The image forming apparatus according to (((2))),
wherein the processor sets the at least one of the start timings such that the blowing start timing comes later than the adjustment processing start timing and such that a time difference between a blowing end timing that is a timing at which blowing of the gas ends, and an adjustment processing end timing that is a timing at which the adjustment processing ends, falls within a predetermined range.

(((4)))

The image forming apparatus according to (((1))),
wherein when the adjustment time is shorter than the blowing time, the processor sets the at least one of the start timings such that the blowing start timing comes earlier than the adjustment processing start timing.

(((5)))

The image forming apparatus according to (((4))),
wherein the processor sets the at least one of the start timings such that the blowing start timing comes earlier than the adjustment processing start timing and a blowing end timing that is a timing at which blowing of the gas ends comes later than the adjustment processing start timing.

(((6))

The image forming apparatus according to (((5))),
wherein the processor sets the at least one of the start timings such that the blowing start timing comes earlier than the adjustment processing start timing, the blowing end timing comes later than the adjustment processing start timing, and a time difference between the blowing end timing and an adjustment processing end timing that is a timing at which the adjustment processing ends falls within a predetermined range.

(((7)))

The image forming apparatus according to (((1))),
wherein when a time difference between the adjustment time and the blowing time is within a predetermined range, the processor sets the at least one of the start timings such that the adjustment processing start timing and the blowing start timing coincide with each other.

(((8)))

The image forming apparatus according to (((7))),
wherein when the time difference is outside the range, the processor sets the at least one of the start timings such that the adjustment processing start timing and the blowing start timing are different from each other.

(((9)))

The image forming apparatus according to (((8))),
wherein the processor sets the at least one of the start timings such that the adjustment processing start timing and the blowing start timing are different from each other and such that an adjustment processing end timing that is a timing at which the adjustment processing ends and a blowing end timing that is a timing at which the blowing of the gas ends coincide with each other.

(((10)))

The image forming apparatus according to (((1))),
wherein when a content of the adjustment processing is changed and the adjustment time has become long while the adjustment processing is being performed, the processor delays a blowing end timing that is a timing at which the blowing of the gas with the blowing unit ends.

(((11)))

The image forming apparatus according to (((10))),
wherein the processor delays the blowing end timing such that the timing at which the adjustment processing ends that has become long and the blowing end timing coincide with each other.

(((12)))

The image forming apparatus according to (((10))) or (((11))),
wherein when the adjustment time has become long, the processor temporarily stops blowing of the gas with the blowing unit or temporarily reduces an output of blowing of the gas with the blowing unit.

(((13)))

An image forming apparatus comprising:
a loading unit on which a recording medium on which an image is to be formed is loaded;
an image forming unit that forms the image, on which adjustment processing is performed before image formation processing on a recording medium starts;
a blowing unit that blows gas onto the recording medium loaded on the loading unit before the image formation processing on the recording medium starts; and
a processor that performs setting of start timing of at least one of adjustment processing start timing that is a timing at which the adjustment processing starts and blowing processing start timing that is a timing at which the blowing starts to cause an adjustment processing end timing that is a timing at which the adjustment processing ends and a blowing end timing that is a timing at which the blowing of the gas with the blowing unit ends to coincide with each other.

(((14)))

A non-transitory computer readable storage medium storing a program executed by a computer provided in an image forming apparatus,
the image forming apparatus comprising:
an image forming unit in which adjustment processing is performed before an image formation processing on a recording medium starts; and
a blowing unit that blows gas onto the recording medium before the image formation processing starts,
the program being for causing the computer to realize a function of setting at least one of a blowing start timing that is a timing at which blowing of the gas starts and an adjustment start timing that is a timing at which the adjustment processing starts based on an adjustment time that is a time in which adjustment of the image forming unit is performed and a blowing time in which the blowing of the gas is performed.

(((15)))

A non-transitory computer readable storage medium storing a program executed by a computer provided in an image forming apparatus,
the image forming apparatus comprising:
   an image forming unit in which adjustment processing is performed before image formation processing on a recording medium starts; and
a blowing unit that blows gas onto the recording medium before the formation processing starts,
the program being for causing the computer to realize a function of setting at least one of an adjustment processing start timing that is a timing at which the adjustment processing starts and a blowing start timing that is a timing at which blowing of the gas starts to cause an adjustment processing end timing that is a timing at which the adjustment processing ends and a blowing end timing that is a timing at which the blowing of the gas with the blowing unit ends to coincide with each other.

What is claimed is:

1. An image forming apparatus comprising:
a loading unit on which a recording medium on which an image is to be formed is loaded;
an image forming unit that forms the image, on which adjustment processing is performed before image formation processing on a recording medium starts;
a blowing unit that blows gas onto the recording medium loaded on the loading unit before the image formation processing on the recording medium starts; and
a processor that sets, based on adjustment time that is a time in which the image forming unit is adjusted and blowing time that is a time in which the gas is blown, start timing of at least one of blowing start timing that is a timing at which blowing of the gas starts and adjustment processing start timing that is a timing at which the adjustment processing starts.

2. The image forming apparatus according to claim 1,
wherein when the adjustment time is longer than the blowing time, the processor sets the at least one of the start timings such that the blowing start timing comes later than the adjustment processing start timing.

3. The image forming apparatus according to claim 2,
wherein the processor sets the at least one of the start timings such that the blowing start timing comes later than the adjustment processing start timing and such that a time difference between a blowing end timing that is a timing at which blowing of the gas ends, and an adjustment processing end timing that is a timing at which the adjustment processing ends, falls within a predetermined range.

4. The image forming apparatus according to claim 1,
wherein when the adjustment time is shorter than the blowing time, the processor sets the at least one of the start timings such that the blowing start timing comes earlier than the adjustment processing start timing.

5. The image forming apparatus according to claim 4,
wherein the processor sets the at least one of the start timings such that the blowing start timing comes earlier than the adjustment processing start timing and a blowing end timing that is a timing at which blowing of the gas ends comes later than the adjustment processing start timing.

6. The image forming apparatus according to claim 5,
wherein the processor sets the at least one of the start timings such that the blowing start timing comes earlier than the adjustment processing start timing, the blowing end timing comes later than the adjustment processing start timing, and a time difference between the blowing end timing and an adjustment processing end timing that is a timing at which the adjustment processing ends falls within a predetermined range.

7. The image forming apparatus according to claim 1,
wherein when a time difference between the adjustment time and the blowing time is within a predetermined range, the processor sets the at least one of the start timings such that the adjustment processing start timing and the blowing start timing coincide with each other.

8. The image forming apparatus according to claim 7,
wherein when the time difference is outside the range, the processor sets the at least one of the start timings such that the adjustment processing start timing and the blowing start timing are different from each other.

9. The image forming apparatus according to claim 8,
wherein the processor sets the at least one of the start timings such that the adjustment processing start timing and the blowing start timing are different from each other and such that an adjustment processing end timing that is a timing at which the adjustment processing ends and a blowing end timing that is a timing at which the blowing of the gas ends coincide with each other.

10. The image forming apparatus according to claim 1,
wherein when a content of the adjustment processing is changed and the adjustment time has become long while the adjustment processing is being performed, the processor delays a blowing end timing that is a timing at which the blowing of the gas with the blowing unit ends.

11. The image forming apparatus according to claim 10,
wherein the processor delays the blowing end timing such that the timing at which the adjustment processing ends that has become long and the blowing end timing coincide with each other.

12. The image forming apparatus according to claim 10,
wherein when the adjustment time has become long, the processor temporarily stops blowing of the gas with the blowing unit or temporarily reduces an output of blowing of the gas with the blowing unit.

13. A non-transitory computer readable storage medium storing a program executed by a computer provided in an image forming apparatus,
the image forming apparatus comprising:
an image forming unit in which adjustment processing is performed before an image formation processing on a recording medium starts; and
a blowing unit that blows gas onto the recording medium before the image formation processing starts,
the program being for causing the computer to realize a function of setting at least one of a blowing start timing that is a timing at which blowing of the gas starts and an adjustment start timing that is a timing at which the adjustment processing starts based on an adjustment time that is a time in which adjustment of the image forming unit is performed and a blowing time in which the blowing of the gas is performed.

14. A non-transitory computer readable storage medium storing a program executed by a computer provided in an image forming apparatus,
the image forming apparatus comprising:
an image forming unit in which adjustment processing is performed before image formation processing on a recording medium starts; and
a blowing unit that blows gas onto the recording medium before the formation processing starts,
the program being for causing the computer to realize a function of setting at least one of an adjustment processing start timing that is a timing at which the adjustment processing starts and a blowing start timing that is a timing at which blowing of the gas starts to cause an adjustment processing end timing that is a timing at which the adjustment processing ends and a blowing end timing that is a timing at which the blowing of the gas with the blowing unit ends to coincide with each other.
